(19) United States
(12) Patent Application Publication
(10) Pub. No.: US 2004/0013423 A1
(43) Pub. Date: Jan. 22, 2004

(54) Camera with viewfinder

(76) Inventors: Benjamin A. Wells, Lincoln, MA (US); Arthur P. Becker, New York, NY (US)

Correspondence Address: FISH & RICHARDSON P.C., 45 ROCKEFELLER PLAZA, SUITE 2800, NEW YORK, NY, 10111, US

(21) Appl. No.: 10/344,498

(22) PCT Filed: Aug. 10, 2001
(86) PCT No.: PCT/US01/41671

(51) Int. Cl. G03B 17/20

(52) U.S. Cl. 396/296

(57) ABSTRACT

A camera with a viewfinder is disclosed that includes a first lens positioned near an objective side of the viewfinder and having a negative optical power and, a second lens having a positive optical power and being positioned at a viewing side of the viewfinder. The first lens and the second lens combine to define a telescope. A partially reflective mirror is disposed between the first lens and the second lens. A framing target is on a surface of the second lens. The framing target is substantially reflective to light passing from the first lens to the second lens, and is located so a reflected image of the framing target is substantially in focus near the viewing side of the viewfinder. The target may, in some cases, be illuminated by artificial light.

### BACKGROUND

This invention relates to photographic cameras and more particularly to photographic cameras with viewfinders.

Some camera viewfinders include a wide angle mode and/or telephoto mode. Telephoto mode can be used to photograph distant objects, whereas wide angle mode can be used to photograph close objects.

In telephoto mode, some viewfinders include a visible framing target to assist a user in framing photographs. They also can include various other indicators to assist the operator in obtaining quality photographs. Such viewfinders typically are used under various ambient light conditions ranging from very bright to very dim.

Framing masks typically can be made non-visible when a camera is adjusted to function in a wide angle mode.

### SUMMARY

In one aspect, a camera is disclosed with a viewfinder including a first lens positioned at an objective side of the viewfinder, the first lens having a negative optical power, a second lens positioned at a viewing side of the viewfinder, the second lens having positive optical power, the first lens and the second lens combining to define a telescope, a partially reflective mirror disposed between the first lens and the second lens and a framing target on a surface of the second lens, the framing target being substantially reflective to light passing from the first lens to the second lens, the partially reflective mirror being located such that a reflected image of the framing target is substantially in focus near the viewing side of the viewfinder.

In another aspect, a camera with a viewfinder is disclosed that includes a lens positioned near a viewing side of the viewfinder, a mirror comprising a first surface substantially parallel to and facing the lens, the first surface of the mirror being at least partially reflective, a pattern disposed between the lens and the mirror and a light source for illuminating the pattern.

In some implementations, one or more of the following advantages may be present. A sharply focused framing target can be visible through a camera's viewfinder. This effect can be achieved through a relatively simple and relatively inexpensive arrangement of components in the viewfinder.

The techniques and methods can provide improved illumination of viewfinder targets and other icons under varying ambient light conditions. These techniques may be particularly useful in inexpensive, single-use cameras having a telephoto mode. However, the techniques of etching, engraving, or molding a pattern on a lens and illuminating that pattern with a light source in the camera can be applied to any camera that uses targets, icons, or other patterns.

Other features and advantages will be readily apparent from the detailed description, the accompanying drawings and the claims.

### BRIEF DESCRIPTION OF THE DRAWINGS

FIG. 1 illustrates a viewfinder of a camera.

FIG. 2 illustrates a framing mask for the camera.

FIG. 3 illustrates another viewfinder of a camera.

FIG. 4 illustrates yet another viewfinder of a camera.

FIG. 5 illustrates a pattern on a camera lens.

### DETAILED DESCRIPTION

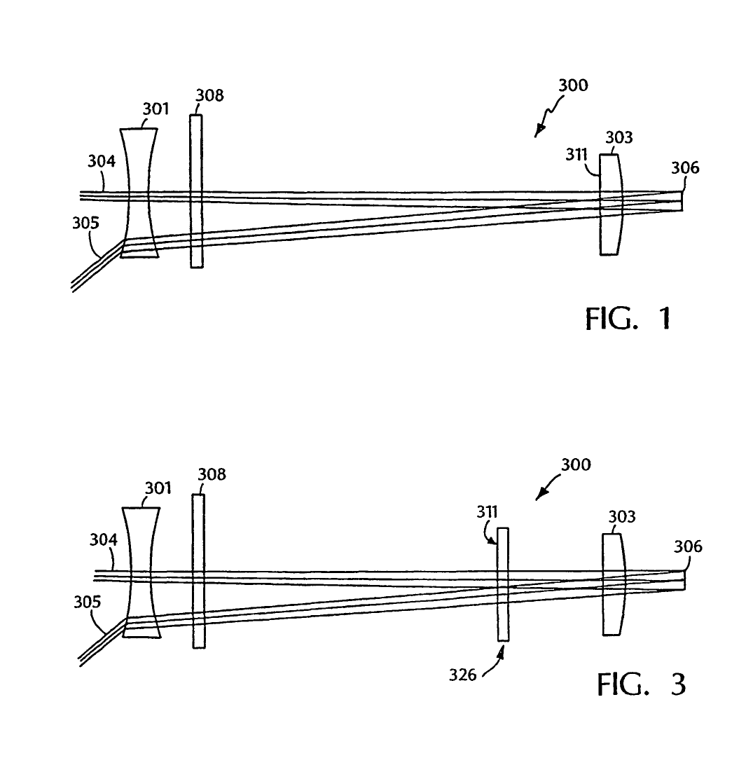

The camera of FIG. 1 includes a viewfinder 300. The camera can be for example, a single-use camera having a wide angle mode as well as a telephoto mode. A front negative lens 301 is positioned on the objective side of the viewfinder 300. The front lens 301 may be, for example, about 20 mm in diameter, and may have an effective focal length of about −40 millimeters (mm). A planar mirror 308 is disposed near the front negative lens 301. The planar mirror 308 preferably has a larger diameter than the front negative lens 301. The planar mirror 308 is partially reflective and may have a reflection ratio of approximately 50%-70% so that approximately 50%-30% of the incident light can pass through the mirror. In one implementation. the planar mirror 308 has a reflection ratio of approximately 70%. The approximately 30% of incident light that can pass through the planar mirror 308 is typically considered sufficiently bright to enable a user to view a brightly lit scene. A positive rear lens 303 is positioned on the opposite side of the planar mirror 308 as the front mirror 301. The rear positive lens 303 can be, for example, about 12 mm in diameter, and can have an effective focal length of about +84 mm. The front tens 301 and the rear lens 303 may be, for example, plastic or glass. A pattern, for example a framing target 311, is attached to the front surface of the positive rear lens 303.

Ray bundles 304 and 305 extend fiom points on a distant object (not shown) to the front surface of front lens 301 in the viewfinder 300. The ray bundles 304 and 305 are redirected by the front lens 301 to converge at a point 306 where an image is in focus on the opposite end of the viewfinder 300. After passing through the front lens 301, the ray bundles 304 and 305 reach the planar mirror 308. A user's eye may be positioned near the point 306 where the image is in focus. The ray bundles 304 and 305 pass through the rear side lens 303 and reach the exit point 306 of the viewfinder 300.

The reflective surface of the planar mirror 308 partially reflects an image of the framing target 311. The partially reflected image passes through the rear lens 303 and is focused at the exit point 306, when the camera is set in telephoto mode.

The viewfinder 300 can exhibit negative magnification power of −2×or greater. If it were desirable for the viewfinder 300 to exhibit positive magnification, zero magnification, or negative magnification of less than −2×, a curved mirror may be used in place of planar mirror 308. In viewfinders having large demagnification, the distance between the planar mirror 308 and the back surface of the front lens 301 should be increased. For example, in a viewfinder 300 having a magnification of about −3×, the mirror 308 can be positioned midway between the front lens 301 and the rear lens 303.

The distance between the front lens 301 and the rear lens 303 can be determined as a function of the camera's dimensions. The power of the rear lens 303 may be set so that the image of the framing target 311 is in focus at infinity. In that case, the focal length of the rear lens 303 is approximately twice the spacing between the front lens 301 and the rear lens 303. The power of the firont lens 301 may be set such that the negative Galilean telescope defined by the front lens 301 and rear lens 303 is focused at infinity. In that case, the focal length of the front lens 301 is approximately half the focal length of the rear lens 303. This implies that the power of the Galilean telescope is approximately −2×. The power of the Galilean telescope can be more strongly negative if desired, but typically cannot be made less than −2×if a planar mirror 308 is used.

The reflectance of the planar mirror 308 should be high enough to provide good contrast of the reflective indicia of the framing mask. The view through the viewfinder can be made dim enough to signal the operator that bright light is needed. The front lens 301 may be cut to a rectangular size to provide rough framing for the image when the wide angle mode of the camera, as opposed to the telephoto mode, is selected. The size of the reflective framing indicia on the framing mask can be selected to provide framing guidance when the telephoto mode of the camera is selected.

In some implementations, the framing target 311 is formed by applying a sticker to the front surface of the rear lens 303, or alternatively, by applying a sticker to a surface of a plate which is separate from the rear lens 303. The plate may be disposed between the planar mirror 308 and the rear lens 303. If a sticker is used to create the framing indicia and masking, it is preferable to cut out the central portion because adhesives utilized in such applications may not be completely transparent and, therefore, images may appear fuzzy when viewed through such adhesives. The framing target 311 also can be applied by hot stamping.

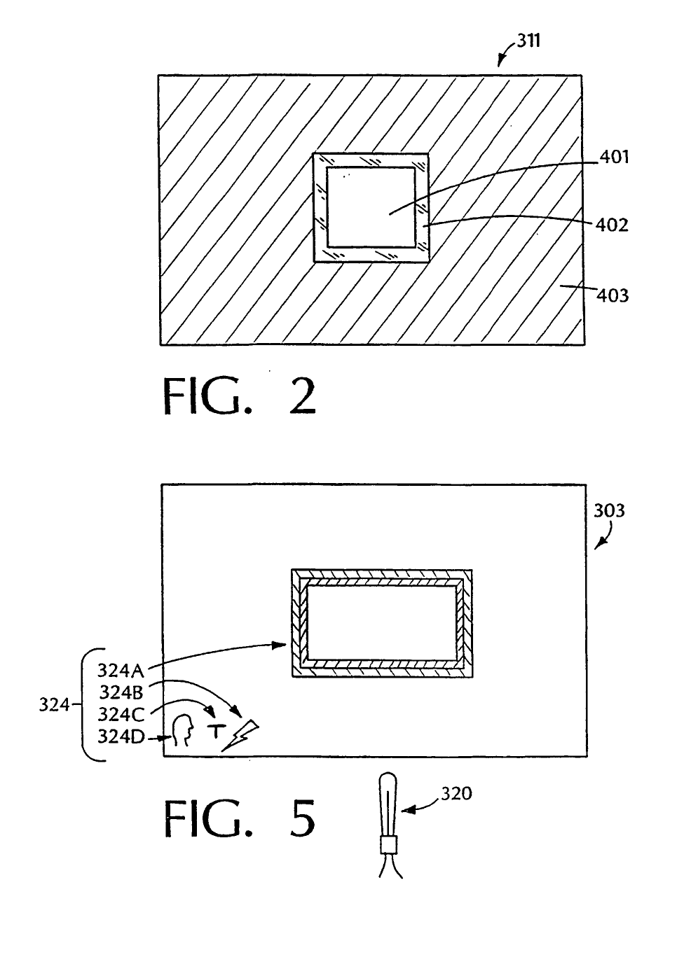

Referring to FIG. 2, a framing target 311 is affixed to the front surface of rear lens 303. A transparent and centrally located hole 401 is surrounded by an area 402 of reflective silver mylar, which in turn is surrounded by a flat black area 403. The pattern can assist a user in framing a scene being viewed through the viewfinder 300.

The viewfinder 300 of FIG. 3 includes a framing pattern 311 located on a transparent plate 326 disposed between the mirror 308 and the lens 303.

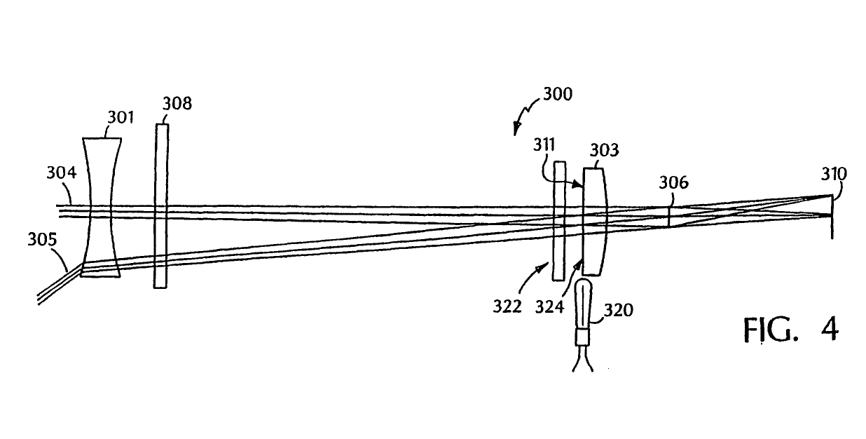

In other implementations, as shown in FIG. 4, a pattern 324 can be formed on lens 303 by etching or engraving one or more grooves in the surface of lens 303. These grooves may be, for example, V-shaped grooves, rectangular grooves, or any other conveniently shaped grooves. The depth of the grooves can vary depending on the particular implementation. The viewfinder 300 can include a light source 320 located adjacent to the pattern 324. The light source 320 can be artificial light source, such as a light emitting diode (LED) or a neon bulb. In some implementations, light is delivered from the light source 320 to illuminate the target through a light pipe such as an optical fiber. The light source 320 should be small and require relatively low amounts of energy to operate. The light source 320 may be mounted to or near lens 303 to illuminate the pattern 324.

Light fiom the source 320 is at least partially reflected by the pattern 324. This partially reflected light travels toward the planar mirror 308 and is again at least partially reflected. The reflected light travels back through the lens 303 and to the exit point 306 of the viewfinder 300. Directing the light toward the pattern 324 can make the pattern 324 highly visible to the eye 310 of a user under various ambient light conditions (e.g., very bright or very dark). The light source 320 preferably emits a colored light. The light source 320 can include one or more individual sources of light situated around the lens 303 to illuminate the pattern 324 from different angles.

An alternate method of providing the pattern 324 can include a plastic mold to on the surface of the lens 303. The mold can include transparent plastic material, but may be formed from other transparent materials as well. In such a case, the pattern 324 would be raised from the surface of lens 303, and light from the source 320 would be reflected from the raised pattern 324, thereby making the raised pattern 324 visible to the eye 310 of a user.

The planar mirror 308 can cause a substantially focused image of the pattern 324 to appear to the eye 310 of a user when the camera is operated in the telephoto mode. The pattern 324 can be made invisible to the eye 310 of a user by moving the planar minor 308 out of the optical plane. For example, when the camera is operated in a mode other than the telephoto mode (e.g., a wide angle mode), the pattern can be brought out of focus, so that it is not visible at the viewing side of the viewfinder.

Parts of the pattern 324 may be made invisible to the eye 310 of a user by inserting a mask 322 between the rear lens 303 and the planar mirror 308. The mask 322 can include transparent areas as well as opaque areas. The opaque areas can be located on the mask 322 so that they at least partially prevent the transmission of light reflected from particular areas of the pattern 324. The mask 322 should be very thin and, when in place, is preferably located close to the lens 303.

As shown in FIG. 5, the front surface of rear lens 303 includes a pattern 324 that can be made visible to the eye of a user looking through the viewfinder. The illustrated pattern 324 includes a framing target 324A and icons 324B, 324C, and 324D. The framing target 324A is substantially rectangular, but it may be square, circular, or any other shape to assist a user in properly framing a photograph. The framing target 324A can be under-framed to provide some tolerance. The illustrated icons include a flashbulb charge indicator symbol 324B, a telephoto mode indicator symbol 324C, and a portrait mode indicator symbol 324D. Those icons can provide a user with information about the operation of the camera and various other conditions.

The pattern 324 can be formed on lens 303 by etching or engraving one or more grooves in the surface of lens 303. These grooves may be, for example, V-shaped grooves, rectangular grooves, or any other conveniently shaped grooves. The depth of the grooves can be varied. Alternatively, the pattern 324 can be molded onto the lens

Techniques generally known in the art may be implemented to prevent light from undesirably scattering throughout different portions of the viewfinder. These techniques can include, for example, darkening portions of the rear lens 303 or installing baffles to direct the light to specific areas only.

One particular implementation includes a viewfinder that can be switched between a first mode that supports the taking of telephoto photographs and a second mode that supports the taking of photographs with a wider image. The viewfinder also can alert an operator of the need for brighter light in telephoto mode and can provide accurate framing marks in telephoto mode.

Viewfinders 300 incorporating the techniques described above can provide relatively inexpensive improvements over known viewfinders. Additionally, the techniques can be implemented using readily available components.

Other implementations are within the scope of the following claims.

What is claimed is:

1. A camera with a viewfinder comprising:
a first lens positioned near an objective side of the viewfinder, the first lens having a negative optical power;
a second lens positioned near a viewing side of the viewfinder, the second lens having a positive optical power, the first lens and the second lens combining to define a telescope;
a partially reflective mirror disposed between the first lens and the second lens; and
a framing target on a surface of the second lens, the framing target being substantially reflective to light passing from the first lens to the second lens, the partially reflective mirror being located such that a reflected image of the framing target is substantially in focus near the viewing side of the viewfinder.

2. The viewfinder of claim 1 wherein the partially reflective mirror is curved and the telescope has a negative optical power of at least −2×.

3. The viewfinder of claim 1 wherein the mirror is planar.

4. The viewfinder of claim 1 wherein a reflected image of the framing target is substantially in focus at an exit point of the viewfinder near the second lens.

5. The viewfinder of claim 1 wherein the mirror is movable to a position in which the reflected image no longer exists at the viewing side of the viewfinder.

6. The viewfinder of claim 1 wherein the framing target is located on a surface of the second lens facing the mirror.

7. The viewfinder of claim 1 wherein the framing target comprises an adhesive sticker.

8. The viewfinder of claim 1 wherein the framing target is attached to the surface by hot stamping.

9. The viewfinder of claim 1 wherein the framing target is engraved into a surface of the second lens facing the mirror.

10. The viewfinder of claim 1 wherein the framing target is molded onto a surface of the second lens.

11. The viewfinder of claim 1 further comprising a mask removably positioned between the lens and the mirror, the mask comprising a translucent portion and an opaque portion.

12. The viewfinder of claim 1 further comprising a light source for illuminating the framing target.

13. The viewfinder of claim 1 further comprising a light source for illuminating the framing target with artificial light.

14. The viewfinder of claim 13 wherein the light source is a light emitting diode.

15. The viewfinder of claim 13 wherein the light source emits a non-white light.

16. The viewfinder of claim 1 wherein the framing target comprises a transparent portion surrounded by a partially translucent band and the partially translucent band is surrounded by a darkened area.

17. The viewfinder of claim 16 wherein the partially translucent band comprises silver mylar.

18. A camera with a viewfinder comprising:
a lens positioned near a viewing side of the viewfinder;
a mirror comprising a first surface substantially parallel to and facing the lens, the first surface of the mirror being at least partially reflective;
a pattern disposed between the lens and the mirror; and
a light source for illuminating the pattern.

19. The camera of claim 18 wherein the pattern is engraved into a first surface of the lens facing the mirror.

20. The camera of claim 18 wherein the pattern includes a plastic mold attached to a surface of the lens facing the mirror.

21. The camera of claim 18 wherein the mirror is movable between a first position in which a reflected image of the pattern is in focus near a viewing side of the lens and a second position in which the reflected image does not exist near the viewing side of the lens.

22. The camera of claim 18 comprising a mask that is positioned between the lens and the mirror to impede passage of a portion of a reflected image of the pattern, the mask comprising translucent portions and opaque portions.

23. The camera of claim 22 wherein the mask is movable to a second position, wherein no portion of the reflected image is impeded from passage

24. The camera of claim 18 wherein the pattern comprises framing indicia.

25. The camera of claim 18 wherein the pattern comprises an icon.

26. The camera of claim 18 wherein the light soruce includes an artificial light source.

27. The camera of claim 18 wherein the light source is a light emitting diode.

28. The camera of claim 18 wherein the light source emits a non-white light.

29. The camera of claim 18 wvlerein the pattern comprises a translucent portion surrounded by a partially translucent band and a darkened area surrounds the partially translucent band.

30. The camera of claim 18 wherein the pattern is attached to a surface of a translucent plate disposed between the lens and the mirror.
